(19) United States
(12) Patent Application Publication
(10) Pub. No.: US 2014/0267030 A1
(43) Pub. Date: Sep. 18, 2014

(54) COMPUTER AND MOUSE CURSOR CONTROL METHOD

(71) Applicant: HON HAI PRECISION INDUSTRY CO., LTD., New Taipei (TW)

(72) Inventor: HUA-WEI WU, New Taipei (TW)

(73) Assignee: HON HAI PRECISION INDUSTRY CO., LTD., New Taipei (TW)

(21) Appl. No.: 14/205,383

(22) Filed: Mar. 12, 2014

(30) Foreign Application Priority Data
Mar. 12, 2013 (TW) 102108563

(51) Int. Cl. G06F 3/0354

(52) U.S. Cl. CPC G06F 3/03547
USPC 345/157

(57) ABSTRACT

A mouse cursor control method, applied in a computer, includes presetting matching data between coordinates of a display and a touch panel; receiving two click gestures at the same time; calculating a middle set of coordinates between the two click gesture on the touch panel and finding a set of coordinates of the display, corresponding to the middle set of coordinates, according to the matching data between coordinates of the display and the touch panel; and controlling the mouse cursor to move on the display to the set of coordinates of the display.

### BACKGROUND

1. Technical Field

The present disclosure generally relates to a computer and a mouse cursor control method applied in the computer.

2. Description of Related Art

Some electronic devices, such as notebook computers, are equipped with a touchpad for controlling a cursor on a display of the device. The touchpad performs many of the same scrolling and cursor positioning functions as a mouse. The touchpad includes two keys functioned as the left mouse button and the right mouse button of the mouse. However, there is room for improvement within the touchpad.

### BRIEF DESCRIPTION OF THE DRAWINGS

Many aspects of the embodiments can be better understood with parameters to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a computer.

FIG. 2 is a schematic view of FIG. 1.

FIG. 3 is a first schematic view of FIG. 2, the touch panel being operated.

FIG. 4 is a second schematic view of FIG. 2.

FIG. 5 is a flow chart of a mouse cursor control method of one embodiment.

### DETAILED DESCRIPTION

The disclosure is illustrated by way of example and not by way of limitation in the figures of the accompanying drawings in which like parameters indicate similar elements. It should be noted that parameters to “an” or “one” embodiment in this disclosure are not necessarily to the same embodiment, and such parameters mean “at least one.”

FIG. 1 shows a computer of an embodiment. The computer includes a computer system 10, a touch panel 30, and a display 50. The computer system 10 is connected to the touch panel 30 and the display 50. The computer system 10 includes a CPU 11, a memory 13, and an input interface 15. The computer system 10 controls a mouse cursor to click or drag icons.

FIG. 2 shows that the computer is a notebook computer. The touch panel 30 may be rectangular, for example. The proportion between the width of the display 50 and the width of the touch panel 30 is a first integral number. The proportion between the length of the display 50 and the length of the touch panel 30 is a second integral number. In one embodiment, the first integral number is two, and the first integral number is one.

FIG. 3 shows that the computer system 10 presets corresponding relationships for sets of coordinates between the display 50 and the touch panel 30. When used, the touch panel 30 is tapped with two fingers, and the touch panel 30 senses two click gestures. The computer system 10 calculates a middle coordinate C1 between the two click gestures on the touch panel 30 and finds the corresponding set of coordinates C2 of the display 50 according to the middle set of coordinates of the two click gestures.

FIG. 4 shows that the touch panel 30 senses another two click gestures at the same time. The computer system 10 calculates the middle set of coordinates C3 between the another two gestures on the touch panel 30 and finds the corresponding set of coordinates C4 of the display 50 according to the middle set of coordinates of the another two click gestures.

FIG. 5 shows a mouse cursor control method of one embodiment including following steps.

In step S201, the computer is started up.

In step S202, the touch panel 30 senses two click gestures at the same time.

In step S203, the computer system 10 calculates the middle set of coordinates between the two click gestures on the touch panel 30.

In step S204, the computer system 10 finds the corresponding set of coordinates of the display 50 according to the middle coordinates between the two click gestures.

In step S205, the computer system 10 controls the mouse cursor to move to the corresponding set of coordinates of the display 50.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A computer, comprising:
a display, configured to display a mouse cursor;
a touch panel, configured to sense two click gestures at the same time; and
a computer system, the computer system presetting corresponding sets of coordinates between the display and the touch panel; the computer system configured to calculate a middle set of coordinates between the two click gestures on the touch panel and to find a set of coordinates of the display, corresponding to the middle set of coordinates, according to the corresponding sets of coordinates between the display and the touch panel; and the computer system configured to control the mouse cursor to move on the display to the set of coordinates of the display.

2. The computer of claim 1, wherein a proportion between a length of the display and the length of the touch panel is a first integral number.

3. The computer of claim 2, wherein the first integral number is one.

4. The computer of claim 1, wherein a proportion between a width of the display and the width of the touch panel is a second integral number.

5. The computer of claim 4, wherein the second integral number is two.

6. A mouse cursor control method, applied in a computer, comprising:
presetting, by a computer system of the computer, corresponding sets of coordinates between a display of the computer and a touch panel of the computer;
sensing, by the touch panel, two click gesture at the same time;
calculating, by the computer system, a middle set of coordinates between the two click gesture on the touch panel and finding a set of coordinates of the display, corresponding to the middle set of coordinates, according to the corresponding sets of coordinates between the display and the touch panel; and
controlling, by the computer system, the mouse cursor to move on the display to the set of coordinates of the display.

7. The mouse cursor control method of claim 6, wherein a proportion between a length of the display and the length of the touch panel is a first integral number.

8. The mouse cursor control method of claim 7, wherein the first integral number is one.

9. The mouse cursor control method of claim 6, wherein a proportion between a width of the display and the width of the touch panel is a second integral number.

10. The mouse cursor control method of claim 9, wherein the second integral number is two.
